(19) United States
(12) Patent Application Publication
(10) Pub. No.: US 2013/0328540 A1
(43) Pub. Date: Dec. 12, 2013

(54) BUCK SWITCHING REGULATOR AND CONTROL CIRCUIT THEREOF

(71) Applicant: Nien-Hui Kung, Hsinchu City (TW)

(72) Inventor: Nien-Hui Kung, Hsinchu City (TW)

(73) Assignee: RICHTEK TECHNOLOGY CORPORATION

(21) Appl. No.: 13/492,660

(22) Filed: Jun. 8, 2012

(51) Int. Cl. G05F 3/02

(52) U.S. Cl. 323/311

(57) ABSTRACT

The present invention discloses a buck switching regulator and a control circuit thereof, wherein the buck switching regulator converts an input voltage to an output voltage. The buck switching regulator includes: a power stage including an upper-gate switch, a lower-gate switch and an inductor, which are coupled to a switching node, wherein the upper-gate switch is electrically connected to the input voltage; a transistor electrically connected between the inductor and the output voltage; and a driver circuit, which controls the upper-gate switch and the lower-gate switch at least according to a current flowing through the transistor.

### BACKGROUND OF THE INVENTION

1. Field of Invention

The present invention relates to a buck switch regulator and a control circuit of a buck switch regulator; particularly, it relates to such buck switch regulator and control circuit for accurately detecting the current of the output terminal to control the conversion between the input voltage and the output voltage.

2. Description of Related Art

FIG. 1 shows a schematic view of a conventional buck switch regulator. The buck switching regulator 10 converts an input voltage Vin to an output voltage Vout. That is, the buck switching regulator 10 converts a higher input voltage Vin to a lower output voltage Vout which charges the battery Bat.

A power stage 14 includes an upper-gate switch Q1, a lower-gate switch Q2 and an inductor L, which are coupled to a switching node N2. The current supplied from the input voltage Vin flows through the upper-gate switch Q1, the inductor L and the resistor RS, to an output terminal (i.e. the output voltage Vout) and also charges the battery Bat. An output current detection circuit 18 acquires a voltage difference between the nodes N3 and N4 across the resistor RS, and outputs a signal AIOUT representing an output current flowing through the resistor RS according to the voltage difference. Likewise, An input current detection circuit 17 acquires a voltage difference between the nodes N1 and N2 across the upper-gate switch Q1, and outputs a signal AIin representing an input current flowing through upper-gate switch Q1 according to the voltage difference. An output voltage detection circuit 19 detects the output voltage Vout at the output terminal and outputs a signal AVout representing the output voltage. A driver circuit 11 generates signals controlling the upper-gate switch Q1 and the lower-gate switch Q2 according to the above-mentioned signals AIin, AIout and AVout, to control the conversion between the input voltage Vin and the output voltage Vout.

However, the resistance of the resistor RS is often temperature-dependent, and different resistors have different resistances. Therefore, the signal AIout often can not accurately represent the output current, such that the driver circuit 11 can not accurately controlling the upper-gate switch Q1 and the lower-gate switch Q2. In addition, the battery Bat may generate a leakage current flowing backward to the lower-gate switch Q2, which results in a loss of charging efficiency.

In view of the above, to overcome the drawbacks in the prior art, the present invention proposes a buck switching regulator and a control circuit of the buck switching regulator for accurately detecting the output current to the output terminal so as to more accurately control the conversion between the input voltage and the output voltage. In addition, the proposed buck switching regulator and the control circuit thereof also prevents the reverse current from flowing backward so as to improve the voltage conversion efficiency and to solve the problem caused by the reverse current.

### SUMMARY OF THE INVENTION

A first objective of the present invention is to provide a buck switching regulator.

A second objective of the present invention is to provide a control circuit of a buck switching regulator.

To achieve the objectives mentioned above, from one perspective, the present invention provides a buck switching regulator for converting an input voltage to an output voltage, comprising: a power stage including an upper-gate switch, a lower-gate switch and an inductor, which are coupled to a switching node, wherein the upper-gate switch is electrically connected to the input voltage, and the lower-gate switch is electrically connected to ground; a transistor electrically connected between the inductor and the output voltage, wherein the transistor includes a body diode for blocking a reverse current flowing from the output voltage toward the lower-gate switch; and a driver circuit, which controls the upper-gate switch and the lower-gate switch at least according to a current flowing through the transistor.

From another perspective, the present invention provides a control circuit of a buck switching regulator, for adjusting a current flowing through an inductor to provide an output current to an output terminal, the control circuit comprising: an upper-gate switch having a first end electrically connected to an input voltage and a second end electrically connected to the inductor; a lower-gate switch having a first end electrically connected to the inductor and a second end electrically connected to ground; a transistor electrically connected between the inductor and the output terminal, wherein the transistor includes a body diode for blocking a reverse current flowing from the output terminal toward the lower-gate switch; and a driver circuit, which controls the upper-gate switch and the lower-gate switch at least according to a current flowing through the transistor.

From another perspective, the present invention provides a control circuit of a buck switching regulator, for controlling a power stage to convert an input voltage to an output voltage, wherein the power stage includes an upper-gate switch, a lower-gate switch and an inductor, which are coupled to a switching node, the upper-gate switch being electrically connected to the input voltage, the lower-gate switch being electrically connected to ground, the control circuit comprising: a transistor electrically connected between the inductor and the output voltage, wherein the transistor includes a body diode for blocking a reverse current flowing from the output voltage toward the lower-gate switch; and a driver circuit, which controls the upper-gate switch and the lower-gate switch at least according to a current flowing through the transistor.

In one preferred embodiment, the transistor is an NMOS transistor, and the buck switching regulator further includes a voltage generator for providing a gate voltage to a gate of the transistor.

In one preferred embodiment, the buck switch regulator further comprises an output current detection circuit, which acquires a voltage difference across the transistor and compares the voltage difference with a reference signal to generate a signal representing an output current.

The objectives, technical details, features, and effects of the present invention will be better understood with regard to the detailed description of the embodiments below.

### BRIEF DESCRIPTION OF THE DRAWINGS

FIG. 1 shows a schematic view of a conventional buck switch regulator.

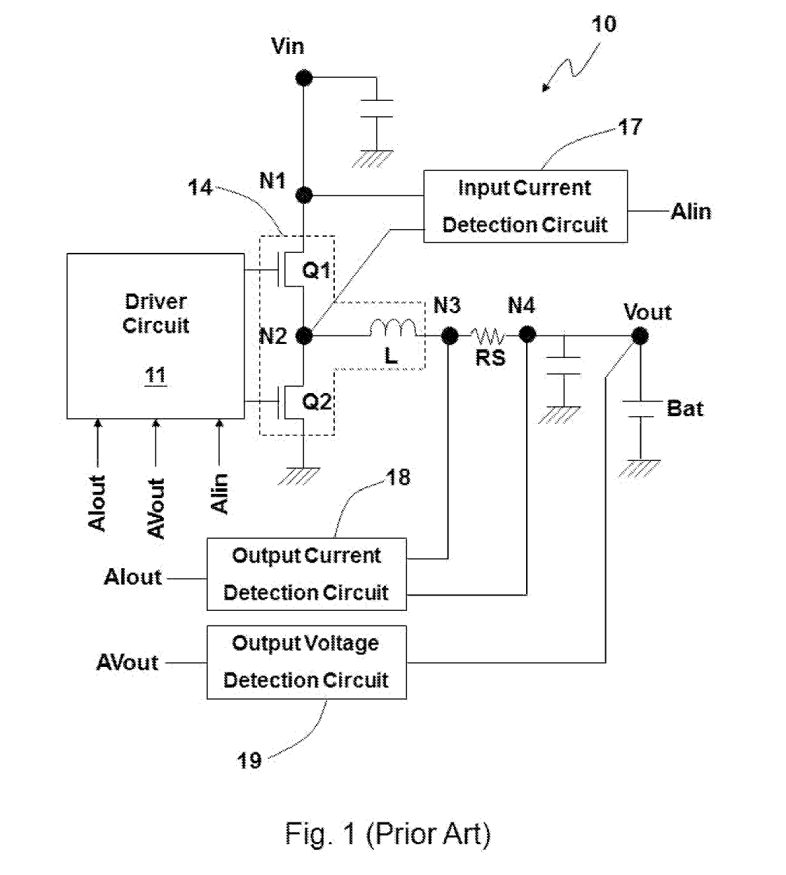

FIG. 2 shows a schematic view of a buck switch regulator according to an embodiment of the present invention.

FIG. 3 shows a schematic view of a buck switch regulator according to another embodiment of the present invention.

### DESCRIPTION OF THE PREFERRED EMBODIMENTS

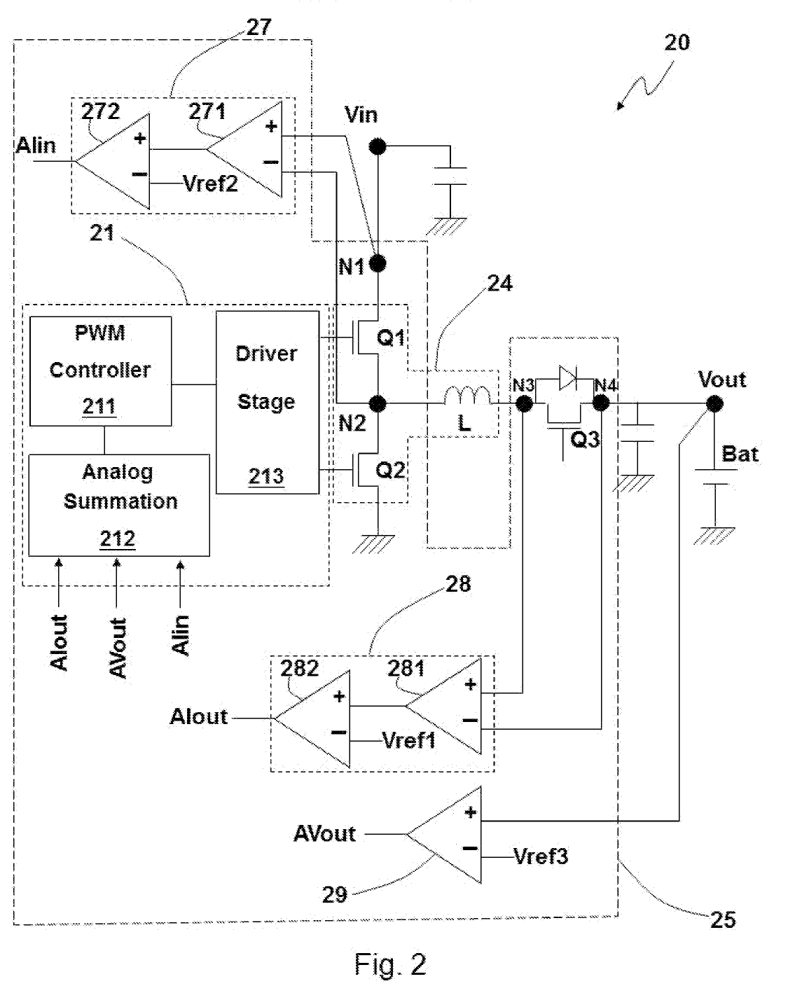

FIG. 2 shows a schematic view of a buck switch regulator according to an embodiment of the present invention. As shown in FIG. 2, the buck switching regulator 20 of this embodiment converts an input voltage Vin to an output voltage Vout. That is, the buck switching regulator 20 of this embodiment converts a higher input voltage Vin with voltage to a lower output voltage Vout which charges the battery Bat.

The buck switching regulator 20 comprises a driver circuit 21, a power stage 24, a transistor Q3, an input current detection circuit 27, an output current detection circuit 28 and an output voltage detection circuit 29. The power stage 24 includes an upper-gate switch Q1, a lower-gate switch Q2 and an inductor L, which are coupled to a switching node N2. The upper-gate switch Q1 is electrically connected to the input voltage Vin; the lower-gate switch Q2 is electrically connected to ground; and the inductor L is electrically connected to the output voltage Vout through the transistor Q3. The current supplied from the input voltage Vin flows through the upper-gate switch Q1, the inductor L and the transistor Q3, to an output terminal (i.e. the output voltage Vout) and also charges the battery Bat. The output current detection circuit 28 acquires a voltage difference between the nodes N3 and N4 across the transistor Q3, and outputs a signal AIout representing an output current flowing through the transistor Q3 according to the voltage difference. The transistor Q3, as compared with the resistor RS used in the prior art, enables the output current detection circuit 28 to detect the output current more stably and accurately. In addition, the transistor Q3 includes a body diode as shown in FIG. 2 for blocking the above-mentioned leakage current flowing backward from the battery Bat.

The input current detection circuit 27 acquires a voltage difference between the nodes N1 and N2 across the upper-gate switch Q1, and outputs a signal AIin representing an input current flowing through upper-gate switch Q1 according to the voltage difference. The output voltage detection circuit 29 detects the output voltage Vout at the output terminal and outputs a signal AVout representing the output voltage. The driver circuit 21 generates signals controlling the upper-gate switch Q1 and the lower-gate switch Q2 according to the above-mentioned signals AIin, AIout and AVout, to control the conversion between the input voltage Vin and the output voltage Vout.

In this embodiment, the output current detection circuit 28 includes error amplifiers 281 and 282, wherein the error amplifier 281 acquires a voltage difference across the transistor Q3 and the error amplifier 282 compares the voltage difference with a first reference signal Vref1 to generate the signal AIout. Likewise, the input current detection circuit 27 includes error amplifiers 271 and 272, wherein the error amplifier 271 acquires a voltage difference across the upper-gate switch Q1 and the error amplifier 272 compares the voltage difference with a second reference signal Vref2 to generate the signal AIin. The output voltage detection circuit 29 is an error amplifier which detects the output voltage Vout at the output terminal and compares the output voltage Vout with a third reference signal Vref3 to output the signal AVout. Certainly, the input current detection circuit 27, the output current detection circuit 28 and the output voltage detection circuit 29 are not limited to the examples illustrated in this embodiment; they can be any other circuits or devices providing equivalent or similar functions.

In this embodiment, the driver circuit 21 includes a pulse width modulation (PWM) controller 211, an analog summation circuit 212 and a driver stage 213. The analog summation circuit 212 sums up the above-mentioned signals AIin, AIout and AVout, or combines these signals in any suitable ways, and generates a corresponding output signal which is sent to the PWM controller 211. The PWM controller 211 generates duty signals; based on the duty signals, the driver stage 213 controls the upper-gate switch Q1 and the lower-gate switch Q2. Certainly, the driver circuit 21 is not limited to the example described in this embodiment; it can be any circuits or devices providing equivalent or similar functions. For example, the upper-gate switch Q1 and the lower-gate switch Q2 can be driven at fixed frequency or modulated frequency. For another example, the driver circuit 21 can simply just obtain the signal representing the output current AIout without obtaining the signals AIin and AVout. The upper-gate switch Q1, the lower-gate switch Q2, the transistor Q3, the input current detection circuit 27, the output current detection circuit 28 and the output voltage detection circuit 29 can be integrated to a control circuit 25 by a semiconductor process. The control circuit 25 and the inductor L or other devices (e.g., the capacitors) as a whole construct a power supplier 20. If the upper-gate switch Q1 and the lower-gate switch Q2 are high voltage power transistors, they can also be disposed outside the control circuit 25.

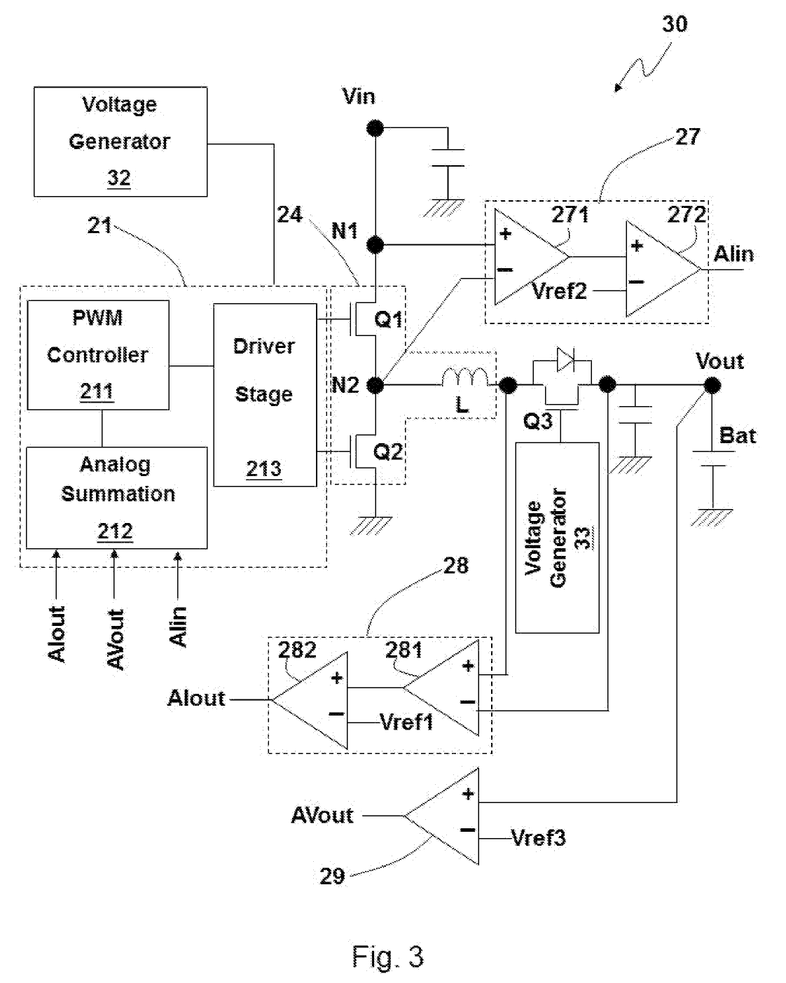

FIG. 3 shows a schematic view of a buck switch regulator according to another embodiment of the present invention. The buck switching regulator 30 comprises a driver circuit 21, a power stage 24, a transistor Q3, an input current detection circuit 27, an output current detection circuit 28, an output voltage detection circuit 29 and two voltage generators 32 and 33. When the upper-gate switch Q1 and the transistor Q3 are NMOS transistors, to be turned ON, their gate voltages are required to be higher than their source voltages. The voltage generators 32 and 33 can provide the required voltages to the gate of the upper-gate switch Q1 and the gate of the transistor Q3. The voltage generators 32 and 33 can be a charge pump or a bootstrap capacitor circuit.

The upper-gate switch Q1, the lower-gate switch Q2, the transistor Q3, the input current detection circuit 27, the output current detection circuit 28, the output voltage detection circuit 29 and the voltage generators 32 and 33 can be integrated to a control circuit by a semiconductor process. The control circuit and the inductor L or other devices (e.g., the capacitors) as a whole construct a power supplier 30. If the upper-gate switch Q1 and the lower-gate switch Q2 are high voltage power transistors, they can also be disposed outside the control circuit.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, the switches or the error amplifiers can be replaced by any other circuits or devices providing equivalent or similar functions. For another example, in the figures shown in all aforementioned embodiments, any other circuits or devices which do not affect the primary function of the circuit or the device can be interposed between any two circuits or devices which are connected to each other directly. For yet another example, the positive input terminal and the negative input terminal of an error amplifier may be interchanged, with corresponding adjustments in circuits processing these signals and the output of the error amplifier. In view of the foregoing, the spirit of the present invention should cover all such and other modifications and variations, which should be interpreted to fall within the scope of the following claims and their equivalents.

What is claimed is:

1. A buck switching regulator for converting an input voltage to an output voltage, comprising:
a power stage including an upper-gate switch, a lower-gate switch and an inductor, which are coupled to a switching node, wherein the upper-gate switch is electrically connected to the input voltage, and the lower-gate switch is electrically connected to ground;
a transistor electrically connected between the inductor and the output voltage, wherein the transistor includes a body diode for blocking a reverse current flowing from the output voltage toward the lower-gate switch; and
a driver circuit, which controls the upper-gate switch and the lower-gate switch at least according to a current flowing through the transistor.

2. The buck switching regulator of claim 1, wherein the transistor is an NMOS transistor, and the buck switching regulator further includes a voltage generator for providing a gate voltage to a gate of the transistor.

3. The buck switching regulator of claim 1, further comprising an output current detection circuit, which acquires a voltage difference across the transistor and compares the voltage difference with a reference signal to generate a signal representing an output current.

4. A control circuit of a buck switching regulator, for adjusting a current flowing through an inductor to provide an output current to an output terminal, the control circuit comprising:
an upper-gate switch having a first end electrically connected to an input voltage and a second end electrically connected to the inductor;
a lower-gate switch having a first end electrically connected to the inductor and a second end electrically connected to ground;
a transistor electrically connected between the inductor and the output terminal, wherein the transistor includes a body diode for blocking a reverse current flowing from the output terminal toward the lower-gate switch; and
a driver circuit, which controls the upper-gate switch and the lower-gate switch at least according to a current flowing through the transistor.

5. The control circuit of claim 4, wherein the transistor is an NMOS transistor, and the buck switching regulator further includes a voltage generator for providing a gate voltage to a gate of the transistor.

6. The control circuit of claim 4, further comprising an output current detection circuit, which acquires a voltage difference across the transistor and compares the voltage difference with a reference signal to generate a signal representing an output current.

7. A control circuit of a buck switching regulator, for controlling a power stage to convert an input voltage to an output voltage, wherein the power stage includes an upper-gate switch, a lower-gate switch and an inductor, which are coupled to a switching node, the upper-gate switch being electrically connected to the input voltage, the lower-gate switch being electrically connected to ground, the control circuit comprising:
a transistor electrically connected between the inductor and the output voltage, wherein the transistor includes a body diode for blocking a reverse current flowing from the output voltage toward the lower-gate switch; and
a driver circuit, which controls the upper-gate switch and the lower-gate switch at least according to a current flowing through the transistor.

8. The control circuit of claim 7, wherein the transistor is an NMOS transistor, and the buck switching regulator further includes a voltage generator for providing a gate voltage to a gate of the transistor.

9. The control circuit of claim 7, further comprising an output current detection circuit, which acquires a voltage difference across the transistor and compares the voltage difference with a reference signal to generate a signal representing an output current.
